(19) United States
(12) Patent Application Publication
(10) Pub. No.: US 2025/0141710 A1
(43) Pub. Date: May 1, 2025

(54) ELECTRONIC DEVICE FOR CONTROLLING EXTERNAL DEVICE, AND CONTROL METHOD THEREFOR

(71) Applicant: Samsung Electronics Co., Ltd., Suwon-si (KR)

(72) Inventor: Minsu LEE, Suwon-si (KR)

(21) Appl. No.: 19/009,181

(22) Filed: Jan. 3, 2025

Related U.S. Application Data
(63) Continuation of application No. PCT/KR2023/011585, filed on Aug. 7, 2023.

(30) Foreign Application Priority Data
Sep. 26, 2022 (KR) 10-2022-0121762

(51) Int. Cl. H04L 12/28

(52) U.S. Cl. CPC H04L 12/2816; H04L 12/2827

(57) ABSTRACT

An electronic device is provided. The electronic device includes a communication interface connected to a first electronic device and a second electronic device, in each of which a hub is built-in, through an access point, memory storing one or more computer programs, and one or more processors communicatively coupled to the communication interface and the memory, wherein the one or more computer programs include computer-executable instructions that, when executed by the one or more processors individually or collectively, cause the electronic device to, based on receiving a user input for controlling an external device connected to the first electronic device, transmit a first control command to the first electronic device through the communication interface, the first control command including an instruction for controlling the external device, identify that a communication error occurred between the first electronic device and the external device, and transmit a second control command through the communication interface, the second control command including an instruction to control that the first control command and identification information of the external device are transmitted to the second device, and the second electronic device communicates with the external device to control the external device, wherein the identification information of the external device is obtained by the first electronic device through near field communication.

### CROSS-REFERENCE TO RELATED APPLICATION(S)

This application is a continuation application, claiming priority under § 365(c), of an International application No. PCT/KR2023/011585, filed on Aug. 7, 2023, which is based on and claims the benefit of a Korean patent application number 10-2022-0121762, filed on Sep. 26, 2022, in the Korean Intellectual Property Office, the disclosure of which is incorporated by reference herein in its entirety.

### BACKGROUND

### 1. Field

The disclosure relates to an electronic device for controlling an external device, and a control method therefor.

### 2. Description of Related Art

Recently, as information and communication technologies developed, it is expected that technologies using various Internet of Things (IoT) environments will be generalized.

IoT technologies have high usability for the purpose of controlling various electronic devices in homes. A user can control electronic devices such as a television (TV), a washing machine, an air conditioner, etc. to respectively perform specialized services in an IoT environment in a home, and can easily share information in this regard.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for controlling an external device, and a control method therefor.

Additional aspects will be set forth in part in the description which follows and, in part, will be apparent from the description, or may be learned by practice of the presented embodiments.

In accordance with an aspect of the disclosure, an electronic device is provided. The electronic device includes a communication interface connected to a first electronic device and a second electronic device, in each of which a hub is built in, through an access point, memory storing one or more computer programs, and one or more processors communicatively coupled to the communication interface and the memory, wherein the one or more computer programs include computer-executable instructions that, when executed by the one or more processors individually or collectively, cause the electronic device to, based on receiving a user input for controlling an external device connected to the first electronic device, transmit a first control command to the first electronic device through the communication interface, the first control command including an instruction for controlling the external device, identify that a communication error occurred between the first electronic device and the external device, and transmit a second control command through the communication interface, the second control command including an instruction to control that the first control command and identification information of the external device are transmitted to the second electronic device, and the second electronic device communicates with the external device to control the external device, wherein the identification information of the external device is obtained by the first electronic device through near field communication.

In accordance with another aspect of the disclosure, a method performed by an electronic device configured to communicate with a first electronic device and a second electronic device, in each of which a hub is built in, through an access point is provided. The method includes, based on receiving a user input for controlling an external device connected to the first electronic device, transmitting a first control command to the first electronic device, the first control command including an instruction for controlling the external device, identifying that a communication error occurred between the first electronic device and the external device, and transmitting a second control command including an instruction for controlling that the first control command and identification information of the external device are transmitted to the second electronic device, and the second electronic device communicates with the external device to control the external device, wherein the identification information of the external device is obtained by the first electronic device through near field communication.

In accordance with another aspect of the disclosure, one or more non-transitory computer-readable storage media storing one or more computer programs including computer-executable instructions that, when executed by one or more processors of an electronic device configured to communicate with a first electronic device and a second electronic device, in each of which a hub is built in, through an access point, individually or collectively, cause the electronic device to perform operations are provided. The operations include, based on receiving a user input for controlling an external device connected to the first electronic device, transmitting a first control command to the first electronic device, the first control command including an instruction for controlling the external device, identifying that a communication error occurred between the first electronic device and the external device, and transmitting a second control command including an instruction for controlling that the first control command and identification information of the external device are transmitted to the second electronic device, and the second electronic device communicates with the external device to control the external device, wherein the identification information of the external device is obtained by the first electronic device through near field communication.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a system according to an embodiment of the disclosure;

FIG. 2 is a block diagram for illustrating a configuration of an electronic device according to an embodiment of the disclosure;

FIGS. 3, 4, and 5 are diagrams for illustrating a method for controlling an external device according to various embodiments of the disclosure;

FIG. 6 is a block diagram for illustrating a detailed configuration of an electronic device according to an embodiment of the disclosure; and

FIG. 7 is a flow chart for illustrating a control method for an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In addition, in the disclosure, expressions such as “have,” “may have,” “include,” and “may include” denote the existence of such characteristics (e.g.: elements such as numbers, functions, operations, and components), and do not exclude the existence of additional characteristics.

Further, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

Also, the expressions “first,” “second,” and the like used in the disclosure may describe various elements regardless of any order and/or degree of importance. Further, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the other element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a generic-purpose processor (e.g.: a central processing unit (CPU) or an application processor (AP)) that can perform the corresponding operations by executing one or more software programs stored in a memory device.

Further, in the embodiments of the disclosure, ‘a module’ or ‘a unit’ may perform at least one function or operation, and may be implemented as hardware or software, or as a combination of hardware and software. Also, a plurality of ‘modules’ or ‘units’ may be integrated into at least one module and implemented as at least one processor, excluding ‘a module’ or ‘a unit’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

Hereinafter, the embodiments according to the disclosure will be described in detail with reference to the accompanying drawings, such that those having ordinary skill in the art to which the disclosure belongs can easily carry out the embodiments.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

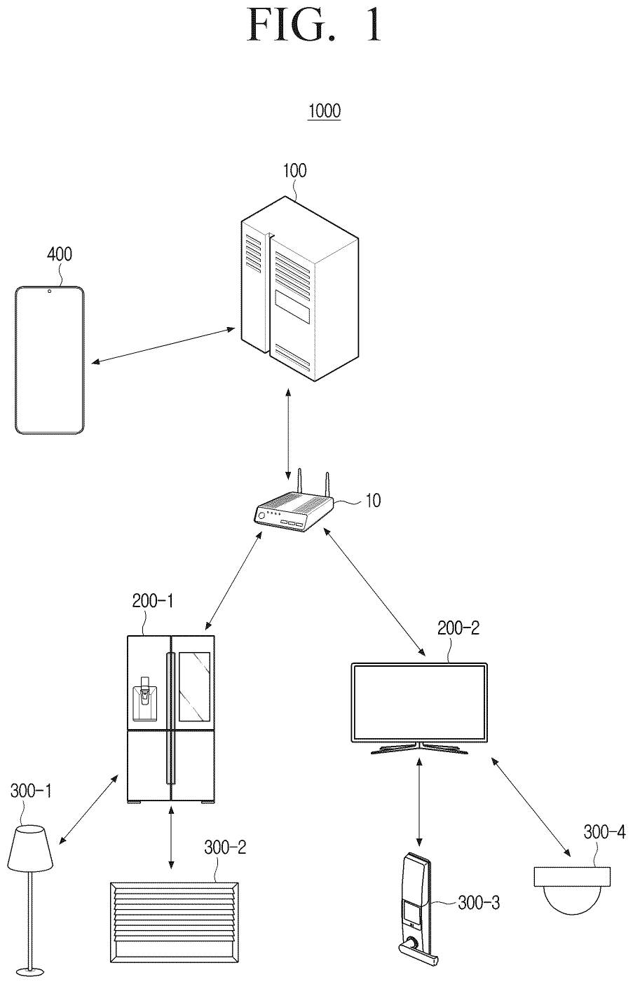

FIG. 1 is a diagram illustrating a system according to an embodiment of the disclosure.

Referring to FIG. 1, a system 1000 may include an electronic device 100, a first electronic device 200-1, a second electronic device 200-2, external devices 300-1 to 300-4, and a user terminal device 400.

The first electronic device 200-1, the second electronic device 200-2, and the external devices 300-1 to 300-4 may be installed in, for example, places such as a home, a company, a factory, etc., and constitute an Internet of Things (IoT) environment.

In this case, the first electronic device 200-1 and the second electronic device 200-2 may be home appliances. Home appliances may include, for example, at least one of a television, a digital versatile disc (DVD) player, an audio, a refrigerator, an air conditioner, a cleaner, an oven, a microwave oven, a washing machine, an air cleaner, a set-top box, an electronic dictionary, an electronic key, a camcorder, or an electronic photo frame. Also, the external devices 300-1 to 300-4 may include at least one of Internet of Things (IoT) devices (e.g.: a light bulb, various types of sensors, an electric or a gas meter, a sprinkler device, a fire alarm, a thermostat, a street light, a toaster, exercise equipment, a hot water tank, a heater, a boiler, etc.).

Here, an IoT environment may mean a state wherein a plurality of electronic devices are connected via a wired/wireless communication network so that any one electronic device among a plurality of electronic devices constituting the IoT environment can perform communication with another electronic device, and share information obtained by the electronic device with the another electronic device, or provide information to a user, or control the another electronic device according to a user input.

For this, in the first electronic device 200-1 and the second electronic device 200-2, a hub may be built in.

In this case, the hub may support a plurality of communication protocols. Here, the plurality of communication protocols may include Zigbee, Z-Wave, Thread, Matter, etc.

As an example, the first electronic device 200-1 may communicate with the second electronic device 200-2 through an Internet protocol (IP) network by using thread communication. In this case, the first electronic device 200-1 and the second electronic device 200-2 may communicate via a router that performs a role of a bridge such as an access point (AP) 10, etc.

As an example, the first electronic device 200-1 and the second electronic device 200-2 may relay communication between the electronic device 100 and the external devices 300-1 to 300-4. That is, the first electronic device 200-1 and the second electronic device 200-2 may transmit signals received from the external devices 300-1 to 300-4 to the electronic device 100 via the IP network through near field communication, or transmit a signal received from the electronic device 100 to the external devices 300-1 to 300-4 via the IP network through near field communication. Here, near field communication may include Zigbee. Also, near field communication may include Z-Wave, etc. In addition, the first electronic device 200-1 and the second electronic device 200-2 may communicate with the electronic device 100 through the access point 10.

Meanwhile, the electronic device 100 may be implemented as a cloud server. As an example, the electronic device 100 may receive various types of information from electronic devices constituting an IoT environment and store the information, and monitor and control the electronic devices.

In this case, a user input for controlling the electronic devices may be received from a user terminal device 400. As illustrated in FIG. 1, the user terminal device 400 may be implemented as a smartphone. However, the disclosure is not limited thereto, and the user terminal device 400 may be implemented as devices in various types that are portable and are equipped with a display function such as a tablet PC, a smart watch, etc.

For example, a user may access the electronic device 100 through an application installed in the user terminal device 400, and input a user input for “turning on a light 300-1.” In this case, the electronic device 100 may transmit a control command for turning on the external device 300-1 to the external device 300-1 through the first electronic device 200-1.

Also, a user input may be input into the first electronic device 200-1 and the second electronic device 200-2. In this case, the user input may be input through user interfaces (UIs) displayed on the displays of the first electronic device 200-1 and the second electronic device 200-2, or input through a voice.

For example, the user may input a user input for “turning on the light 300-1” through the first electronic device 200-1. In this case, the first electronic device 200-1 may transmit a control command for turning on the external device 300-1 to the external device 300-1.

Meanwhile, in case the first electronic device 200-1 cannot communicate with the external device 300-1, the first electronic device 200-1 cannot transmit a control command for controlling the external device 300-1 to the external device 300-1.

In this case, according to an embodiment of the disclosure, the electronic device 100 may make the second electronic device 200-2 control the external device 300-1 by communicating with the external device 300-1. That is, in case one hub cannot normally perform communication with an external device through Zigbee, Z-Wave, etc., control may be performed such that communication with the external device can be performed through another hub. As described above, according to an embodiment of the disclosure, characteristics of a mesh network can be provided for Zigbee, Z-Wave, etc., and thus the user's convenience can be further improved.

Meanwhile, in FIG. 1, it was illustrated that two electronic devices (i.e., the first electronic device 200-1 and the second electronic device 200-2) are connected to the electronic device 100 through the access point. However, this is merely an example, and three or more electronic devices, in each of which a hub is built in, may be connected to the electronic device 100 through the access point.

Also, in FIG. 1, it was illustrated that two external devices (i.e., the external devices 300-1, 300-2) are connected to the first electronic device 200-1, and two external devices (i.e., the external devices 300-3, 300-4) are connected to the second electronic device 200-2. However, this is merely an example, and to each of the first electronic device 200-1 and the second electronic device 200-2, at least one external device may be connected.

Meanwhile, in the disclosure, the first electronic device 200-1 and the second electronic device 200-2 are merely distinguished for the convenience of explanation. Accordingly, unless there is special explanation, explanation for the first electronic device 200-1 can be applied identically to the second electronic device 200-2, and explanation for the second electronic device 200-2 can be applied identically to the first electronic device 200-1.

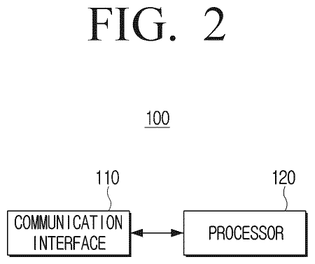

FIG. 2 is a block diagram for illustrating a configuration of an electronic device according to an embodiment of the disclosure.

Referring to FIG. 2, the electronic device 100 may include a communication interface 110 and at least one processor 120.

The communication interface 110 includes circuitry. The communication interface 110 may communicate with a plurality of electronic devices through the IP network. For example, the communication interface 110 may communicate with a plurality of electronic devices through the access point 10 by using the IP network. For this, the communication interface 110 may include a communication module that can perform communication through the IP network.

In this case, in each of the plurality of electronic devices, a hub may be built in. That is, the communication interface 110 may communicate with the plurality of electronic devices, in each of which a hub is built in, through the access point. For example, the communication interface 110 may be connected with the first electronic device 200-1 and the second electronic device 200-2, in each of which a hub is built in, through the access point.

The at least one processor 120 may be electrically connected with the communication interface 110, and control the overall operations and functions of the electronic device 100.

The at least one processor 120 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 120 may control one or a random combination of the other components of the electronic device 100, and perform an operation related to communication or data processing. Also, the at least one processor 120 may execute one or more programs or instructions stored in the memory. For example, the at least one processor 120 may perform the method according to an embodiment of the disclosure by executing the one or more instructions stored in the memory.

Meanwhile, in case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 120 may be implemented as a single core processor including one core, or it may be implemented as one or more multicore processors including a plurality of cores (e.g., multicores of the same kind or multicores of different kinds). In case the at least one processor 120 is implemented as multicore processors, each of the plurality of cores included in the multicore processors may include internal memory of the processor such as cache memory, on-chip memory, etc., and a common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto.

Meanwhile, hereinafter, the at least one processor 120 will be referred to as the processor 120.

First, if a user input for controlling the external device 300-1 connected to the first electronic device 200-1 is received, the processor 120 transmits a control command for controlling the external device 300-1 to the first electronic device 200-1 through the communication interface 110.

Here, the user input may be input through the user terminal device 400. For example, the user may access the electronic device 100 through an application installed in the user terminal device 400, and input a user input for “turning on the light 300-1.” In this case, the processor 120 may transmit a control command for turning on the external device 300-1 to the first electronic device 200-1 through the communication interface 110.

Also, the feature that the first electronic device 200-1 was connected to the external device 300-1 may mean that there is history that the first electronic device 200-1 was connected to the external device 300-1 through near field communication.

Here, near field communication may include Zigbee, Z-Wave, etc. For example, the first electronic device 200-1 may find the external devices 300-1, 300-2 for which Zigbee communication is possible around the first electronic device 200-1 by using a Zigbee communication method, and may be connected to the external devices 300-1, 300-2 by performing a process such as paring, etc. with the external devices 300-1, 300-2. In the case of performing such a process, the first electronic device 200-1 may communicate with the external device 300-1, and it can be deemed that there is history that the first electronic device 200-1 was connected to the external device 300-1.

Meanwhile, the processor 120 may identify whether a communication error occurred between the first electronic device 200-1 and the external device 300-1.

Here, the feature that a communication error occurred may mean a case wherein the first electronic device 200-1 cannot perform communication with the external device 300-1.

For example, the first electronic device 200-1 can communicate with the external device 300-1 through a dongle connected (or, attached) to the first electronic device 200-1. The dongle may perform a function of transmitting a signal to the external device 300-1, or receiving a signal transmitted by the external device 300-1. That is, the dongle may perform a function as an interface for communication with the external device 300-1. Accordingly, in case the dongle gets in an error state due to breakdown, etc., the first electronic device 200-1 cannot perform communication with the external device 300-1.

As another example, a hub is built in the first electronic device 200-1. In this case, the hub supports a plurality of communication protocols (e.g., Zigbee, Z-Wave, Thread, Matter, etc.), and the first electronic device 200-1 can communicate with the second electronic device 200-2 and the external devices 300-1, 300-2 through this. Accordingly, in case the hub gets in an error state due to breakdown, etc., the first electronic device 200-1 cannot perform communication with the external device 300-1.

As described above, in case the dongle or the hub gets in an error state, the first electronic device 200-1 cannot perform communication with the external device 300-1.

Meanwhile, in case at least one of the dongle or the hub is in an error state, the first electronic device 200-1 may transmit a signal indicating that at least one of the dongle or the hub is in an error state to the electronic device 100. For example, the first electronic device 200-1 may transmit a signal indicating that at least one of the dongle or the hub is in an error state to the electronic device 100 through the access point 10 by using the IP network. Accordingly, when the signal is received from the first electronic device 200-1 through the communication interface 110, the processor 120 may identify whether at least one of the dongle or the hub is in an error state. In case at least one of the dongle or the hub of the first electronic device 200-1 is in an error state, the processor 120 may identify that a communication error occurred between the first electronic device 200-1 and the external device 300-1.

For this, the first electronic device 200-1 may detect whether the dongle and the hub are in an error state. For example, the first electronic device 200-1 may detect whether the dongle and the hub are in an error state by using a diagnosis program, etc. installed in the first electronic device 200-1. In this case, when a control command is received from the electronic device 100, the first electronic device 200-1 may detect whether the dongle and the hub are in an error state. Then, if it is identified that at least one of the dongle or the hub is in an error state, the first electronic device 200-1 may transmit a signal indicating this to the electronic device 100.

Meanwhile, in case a communication error did not occur between the first electronic device 200-1 and the external device 300-1, the first electronic device 200-1 may transmit a control command for controlling the external device 300-1 to the external device 300-1. In this case, the external device 300-1 may perform an operation corresponding to the control command received from the first electronic device 200-1.

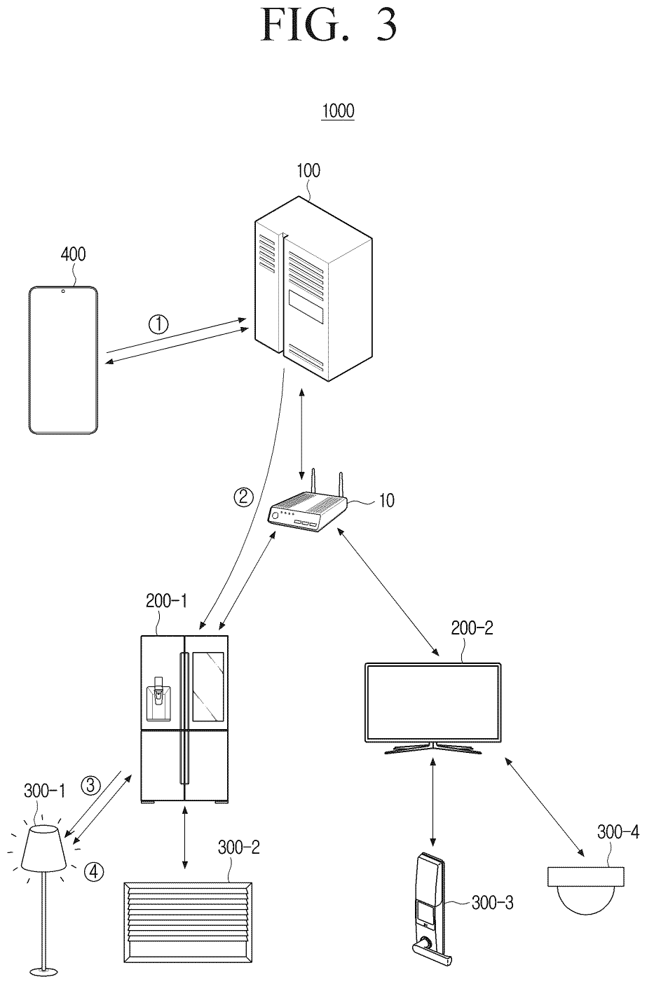

FIGS. 3, 4, and 5 are diagrams for illustrating a method for controlling an external device according to various embodiments of the disclosure.

For example, referring to FIG. 3, if a user input for “turning on the light 300-1” is received (\textcircled{1} in FIG. 3), the processor 120 may transmit a control command for turning on the external device 300-1 to the first electronic device 200-1 (\textcircled{2} in FIG. 3). Then, the first electronic device 200-1 may transmit the control command for turning on the external device 300-1 to the external device 300-1 by using Zigbee communication (\textcircled{3} in FIG. 3). Accordingly, the external device 300-1 may turn on the power based on the received control command (\textcircled{4} in FIG. 3).

Meanwhile, if it is identified that a communication error occurred between the first electronic device 200-1 and the external device 300-1, in order for the second electronic device 200-2 to control the external device 300-2 by communicating with the external device 300-1, the processor 120 controls such that the control command for controlling the external device 300-1 and identification information of the external device 300-1 obtained by the first electronic device 200-1 through near field communication are transmitted to the second electronic device 200-2.

Here, the identification information of the external device 300-1 may include the identification (ID), the address, etc. of the external device 300-1. As can be seen from this, the identification information may include information necessary for near field communication with the external device 300-1.

For this, the first electronic device 200-1 may obtain identification information of the external devices 300-1, 300-2 in a process of being connected to the external devices 300-1, 300-2 by using near field communication, and store the obtained identification information in the memory of the first electronic device 200-1. Also, the first electronic device 200-1 may transmit the obtained identification information to the electronic device 100. In this case, when the identification information of the external devices 300-1, 300-2 are received from the first electronic device 200-1 through the communication interface 110, the processor 120 may store the received identification information in the memory of the electronic device 100.

First, in case the dongle is in an error state, the processor 120 may control the first electronic device 200-1 such that the control command and the identification information of the external device 300-1 stored in the first electronic device 200-1 are transmitted to the second electronic device 200-2.

That is, in case the dongle is in an error state, the first electronic device 200-1 cannot communicate with the external device 300-1, but it may communicate with the second electronic device 200-2 through the IP network by using the hub built inside the first electronic device 200-1.

Accordingly, in case the dongle is in an error state, the processor 120 may transmit, to the first electronic device 200-1, a control command for controlling the external device 300-1 and a signal requesting to transmit the identification information of the external device 300-1 stored in the first electronic device 200-1 to the second electronic device 200-2 through the communication interface 110.

In this case, when the signal is received from the electronic device 100, the first electronic device 200-1 may transmit the control command for controlling the external device 300-1 and the identification information of the external device 300-1 stored in the first electronic device 200-1 to the second electronic device 200-2 by using the hub built in the first electronic device 200-1. For example, the first electronic device 200-1 may transmit the control command and the identification information of the external device 300-1 to the second electronic device 200-2 through the IP network by using thread communication.

Accordingly, the second electronic device 200-2 may communicate with the external device 300-1 by using the identification information received from the first electronic device 200-1, and transmit the control command to the external device 300-1 (e.g., unicast or multicast). In this case, the external device 300-1 may perform an operation corresponding to the control command received from the second electronic device 200-2.

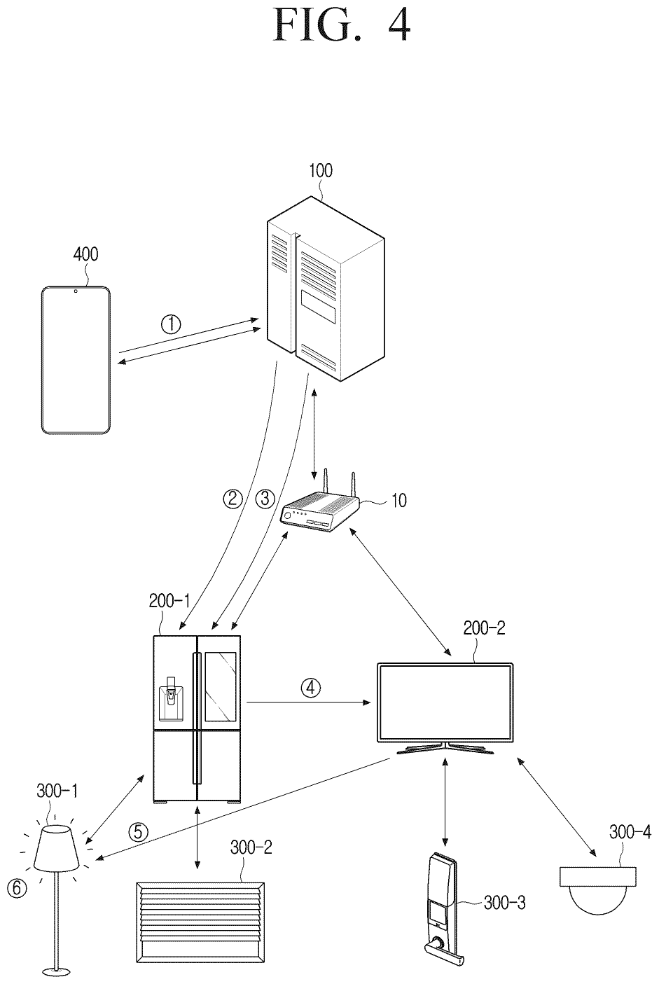

For example, referring to FIG. 4, if a user input for “turning on the light 300-1” is received (\textcircled{1} in FIG. 4), the processor 120 may transmit a control command for turning on the external device 300-1 to the first electronic device 200-1 (\textcircled{2} in FIG. 4).

Meanwhile, if it is identified that the dongle connected to the first electronic device 200-1 is in an error state, the processor 120 may transmit, to the first electronic device 200-1, a control command for turning on the external device 300-1 and a signal requesting to transmit the ID, the address, etc. of the external device 300-1 stored in the first electronic device 200-1 to the second electronic device 200-2 through the communication interface 110 (\textcircled{3} in FIG. 4).

Accordingly, the first electronic device 200-1 may transmit the control command for turning on the external device 300-1 and the ID, the address, etc. of the external device 300-1 to the second electronic device 200-2 (\textcircled{4} in FIG. 4), and the second electronic device 200-2 may communicate with the external device 300-1 through Zigbee communication by using the ID, the address, etc. received from the first electronic device 200-1, and transmit the control command for turning on the external device 300-1 to the external device 300-1 (\textcircled{5} in FIG. 4). Accordingly, the external device 300-1 may turn on the power based on the received control command (\textcircled{6} in FIG. 4).

Meanwhile, in case the hub built in the first electronic device 200-1 is in an error state, the processor 120 may transmit the control command and the identification information of the external device 300-1 stored in the electronic device 100 to the second electronic device 200-2 through the communication interface 110.

That is, in case the hub is in an error state, the first electronic device 200-1 cannot communicate with the external device 300-1 and the second electronic device 200-2.

Accordingly, in case the hub is in an error state, the processor 120 may transmit the control command for controlling the external device 300-1 and the identification information of the external device 300-1 stored in the electronic device 100 to the second electronic device 200-2 through the communication interface 110.

In this case, the second electronic device 200-2 may communicate with the external device 300-1 by using the identification information received from the electronic device 100, and transmit the control command to the external device 300-1 (e.g., unicast or multicast). Then, the external device 300-1 may perform an operation corresponding to the control command received from the second electronic device 200-2.

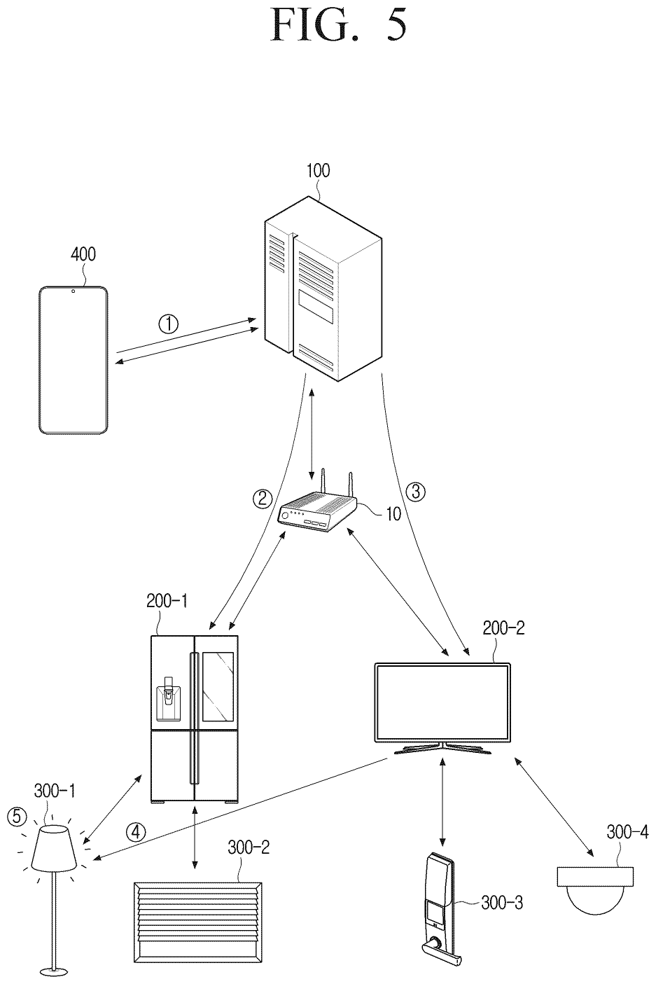

For example, referring to FIG. 5, if a user input for “turning on the light 300-1” is received (\textcircled{1} in FIG. 5), the processor 120 may transmit a control command for turning on the external device 300-1 to the first electronic device 200-1 (\textcircled{2} in FIG. 5).

Meanwhile, if it is identified that the hub built in the first electronic device 200-1 is in an error state, the processor 120 may transmit a control command for turning on the external device 300-1 and the ID, the address, etc. of the external device 300-1 stored in the electronic device 100 to the second electronic device 200-2 through the communication interface 110 (\textcircled{3} in FIG. 5).

Accordingly, the second electronic device 200-2 may communicate with the external device 300-1 through Zigbee communication by using the ID, the address, etc. received from the electronic device 100, and transmit the control command for turning on the external device 300-1 to the external device 300-1 (\textcircled{4} in FIG. 5). Accordingly, the external device 300-1 may turn on the power based on the received control command (\textcircled{5} in FIG. 5).

Meanwhile, in the aforementioned example, it was described that, in case the dongle is in an error state, the first electronic device 200-1 transmits the control command and the identification information of the external device 300-1 to the second electronic device 200-2. However, this is merely an example, and in case the dongle is in an error state, the processor 120 may transmit the control command for controlling the external device 300-1 and the identification information of the external device 300-1 stored in the electronic device 100 to the second electronic device 200-2 through the communication interface 110.

As described above, according to the disclosure, in case one hub cannot perform communication with an external device, communication with the external device can be performed through another hub, and thus the user's convenience can be further improved.

As described above, the processor 120 may control the external device 300-1 by using the second electronic device 200-2 connected to the first electronic device 200-1 through the access point.

Here, in case a plurality of electronic devices are connected to the first electronic device 200-1 through the access point, the processor 120 may select one electronic device among the plurality of electronic devices, i.e., the second electronic device 200-2, and control the external device 300-1 by using the second electronic device 200-2. Meanwhile, there may be a case wherein the second electronic device 200-2 cannot communicate with the external device 300-1. In this case, the processor 120 may control the external device 300-1 by using another electronic device among the plurality of electronic devices.

In the aforementioned example, the processor 120 may randomly select the second electronic device 200-2 and the other electronic device among the plurality of electronic devices.

Also, the processor 120 may select the second electronic device 200-2 and the other electronic device among the plurality of electronic devices based on priorities.

For example, if it is identified that a communication error occurred between the second electronic device 200-2 and the external device 300-1, in order for a third electronic device, among a plurality of electronic devices which are connected through the access point 10 and in each of which a hub is built in, to control the external device 300-1 by communicating with the external device 300-1, the processor 120 may control such that the control command and the identification information of the external device 300-1 are transmitted to the third electronic device.

Specifically, the processor 120 may, based on the strength of signals received among the plurality of electronic devices, identify priorities of the plurality of electronic devices on the basis of the first electronic device 200-1, and identify the second electronic device 200-2 having the highest priority among the plurality of electronic devices based on the priorities. Then, if it is identified that a communication error occurred between the second electronic device 200-2 and the external device 300-1, the processor 120 may identify the third electronic device having the second highest priority after the second electronic device 200-2 among the plurality of electronic devices.

Here, the strength of the received signals may mean the strength of the signals that the first electronic device 200-1 received from the plurality of electronic devices. For example, in a process of finding and connecting a plurality of electronic devices for which thread communication is possible by using thread communication, the first electronic device 200-1 may receive signals from the plurality of electronic devices. Then, the first electronic device 200-1 may identify the strength of the received signals, and transmit information on the strength of the signals identified for each electronic device to the electronic device 100. In this case, when the information on the signal strength is received through the communication interface 110, the processor 120 may set priorities for the plurality of electronic devices in the order of having higher signal strength.

Accordingly, if it is identified that a communication error occurred between the first electronic device 200-1 and the external device 300-1, the processor 120 may identify the electronic device having the highest priority among the plurality of electronic devices, e.g., the second electronic device 200-2, and control such that the control command and the identification information of the external device 300-1 are transmitted to the second electronic device 200-2.

Meanwhile, a communication error may occur between the second electronic device 200-2 and the external device 300-1. In this case, the processor 120 may identify the electronic device having the second highest priority after the second electronic device among the plurality of electronic devices, e.g., the third electronic device, and control such that the control command and the identification information of the external device 300-1 are transmitted to the third electronic device.

In this case, the processor 120 may transmit the control command for controlling the external device 300-1 and the identification information of the external device 300-1 stored in the electronic device 100 to the third electronic device through the communication interface 110. Also, the processor 120 may transmit, to the second electronic device 200-2, the control command for controlling the external device 300-1 and a signal requesting to transmit the identification information of the external device 300-1 stored in the second electronic device 200-2 to the third electronic device through the communication interface 110. In addition, the processor 120 may transmit, to the first electronic device 200-1, the control command for controlling the external device 300-1 and a signal requesting to transmit the identification information of the external device 300-1 stored in the first electronic device 200-1 to the third electronic device through the communication interface 110.

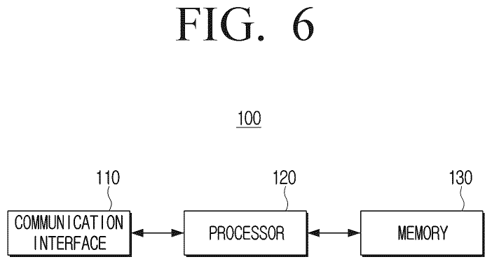

FIG. 6 is a block diagram for illustrating a detailed configuration of an electronic device according to an embodiment of the disclosure.

Referring to FIG. 6, the electronic device 100 may include a communication interface 110, a processor 120, and memory 130. However, these components are merely exemplary ones, and it is obvious that in carrying out the disclosure, new components may be added in addition to these components or some components may be omitted. Meanwhile, in explaining FIG. 6, explanation overlapping with FIG. 1 to FIG. 5 will be omitted.

The memory 130 may store instructions or programs related to at least one component of the electronic device 100. For this, the memory 130 may be implemented as non-volatile memory, volatile memory, flash-memory, a hard disc drive (HDD) or a solid state drive (SSD), etc. Further, the memory 130 may be accessed by the processor 120, and reading/recording/correcting/deleting/updating, etc. of data by the processor 120 may be performed. Meanwhile, in the disclosure, the term memory may include memory 130, read only memory (ROM) (not shown) and random access memory (RAM) (not shown) inside the processor 120, or a memory card (not shown) (e.g., a micro secure digital (SD) card, a memory stick) installed on the electronic device 100.

Also, the memory 130 may store information received from electronic devices constituting an IoT environment. For example, the memory 130 may store identification information of external devices, information on priorities regarding a plurality of electronic devices, etc.

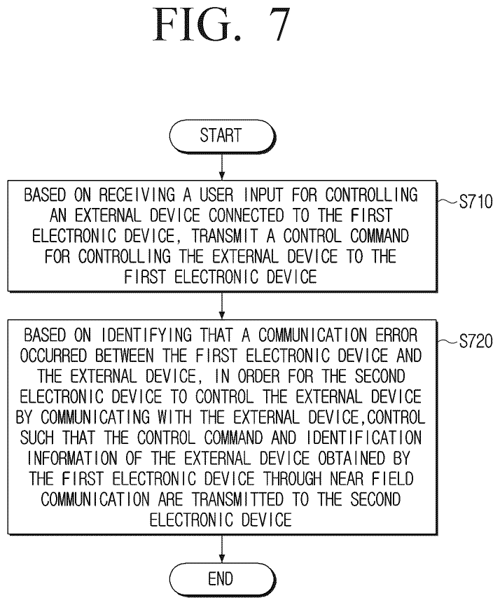

FIG. 7 is a flow chart for illustrating a control method for an electronic device according to an embodiment of the disclosure.

Here, an electronic device may communicate with a first electronic device and a second electronic device, in each of which a hub is built in, through an access point.

First, if a user input for controlling an external device connected to the first electronic device is received, a control command for controlling the external device is transmitted to the first electronic device in the step S710.

Then, if it is identified that a communication error occurred between the first electronic device and the external device, in order for the second electronic device to control the external device by communicating with the external device, control is performed such that the control command and identification information of the external device obtained by the first electronic device through near field communication are transmitted to the second electronic device in the step S720.

Here, near field communication may be Zigbee communication.

Also, the first electronic device may communicate with an external device through a dongle connected to the first electronic device.

In this case, in the step S720, in case at least one of the dongle or the hub built in the first electronic device is in an error state, it may be identified that a communication error occurred between the first electronic device and the external device.

Also, in the step S720, in case the dongle is in an error state, the first electronic device may be controlled such that the control command and identification information of the external device stored in the first electronic device are transmitted to the second electronic device. In this case, the first electronic device may transmit the control command and the identification information of the external device to the second electronic device through the IP network by using the hub built in the first electronic device.

In addition, in the step S720, in case the hub built in the first electronic device is in an error state, the control command and the identification information of the external device stored in the first electronic device may be transmitted to the second electronic device.

Also, if it is identified that a communication error occurred between the second electronic device and the external device, in order for a third electronic device, among a plurality of electronic devices which are connected through the access point and in each of which a hub is built in, to control the external device by communicating with the external device, control may be performed such that the identification information of the external device and the control command are transmitted to the third electronic device.

In this case, based on the strength of signals received among the plurality of electronic devices, priorities of the plurality of electronic devices may be identified on the basis of the first electronic device, and the second electronic device having the highest priority among the plurality of electronic devices may be identified based on the priorities.

Also, if it is identified that a communication error occurred between the second electronic device and the external device, the third electronic device having the second highest priority after the second electronic device among the plurality of electronic devices may be identified.

Meanwhile, according to an embodiment of the disclosure, the method according to the embodiments of the disclosure may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or may be distributed directly between two user devices (e.g.: smartphones), and distributed on-line (e.g.: download or upload) through an application store (e.g.: Play Store™). In the case of on-line distribution, at least a portion of a computer program product (e.g.: a downloadable app) may be stored in a storage medium such as the server of the manufacturer, the server of the application store, and the memory of the relay server at least temporarily, or may be generated temporarily.

Also, each of the components (e.g.: a module or a program) according to the aforementioned various embodiments of the disclosure may consist of a singular object or a plurality of objects. In addition, among the aforementioned corresponding sub components, some sub components may be omitted, or other sub components may be further included in the various embodiments. Alternatively or additionally, some components (e.g.: a module or a program) may be integrated as an object, and perform the functions performed by each of the components before integration identically or in a similar manner.

Further, operations performed by a module, a program, or other components according to the various embodiments may be executed sequentially, in parallel, repetitively, or heuristically. Or, at least some of the operations may be executed in a different order or omitted, or other operations may be added.

Meanwhile, the term “a part” or “a module” used in the disclosure may include a unit consisting of hardware, software, or firmware, and may be interchangeably used with, for example, terms such as a logic, a logical block, a component, or circuitry. In addition, “a part” or “a module” may be a component constituted as an integrated body or a minimum unit or a part thereof performing one or more functions. For example, a module may be constituted as an application-specific integrated circuit (ASIC).

Meanwhile, a non-transitory computer-readable medium storing a program that sequentially performs the control method according to the disclosure may be provided. A non-transitory computer-readable medium refers to a medium that stores data semi-permanently, and is readable by machines, but not a medium that stores data for a short moment such as a register, a cache, and memory. Specifically, the aforementioned various applications or programs may be provided while being stored in a non-transitory computer-readable medium such as a CD, a DVD, a hard disc, a blue-ray disc, a USB, a memory card, ROM and the like.

Also, the embodiments of the disclosure may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: an electronic device 100).

In case an instruction is executed by a processor, the processor may perform a function corresponding to the instruction by itself, or by using other components under its control. An instruction may include a code that is generated or executed by a compiler or an interpreter.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication interface connected to a first electronic device and a second electronic device, in each of which a hub is built in, through an access point;
memory storing one or more computer programs; and
one or more processors communicatively coupled to the communication interface and the memory,
wherein the one or more computer programs include computer-executable instructions that, when executed by the one or more processors individually or collectively, cause the electronic device to:
based on receiving a user input for controlling an external device connected to the first electronic device, transmit a first control command to the first electronic device through the communication interface, the first control command including an instruction for controlling the external device,
identify that a communication error occurred between the first electronic device and the external device, and
transmit a second control command through the communication interface, the second control command including an instruction to control that:
the first control command and identification information of the external device are transmitted to the second electronic device, and
the second electronic device communicates with the external device to control the external device,
wherein the identification information of the external device is obtained by the first electronic device through near field communication.

2. The electronic device of claim 1,
wherein the first electronic device is configured to:
communicate with the external device through a dongle connected to the first electronic device, and
wherein the one or more computer programs include computer-executable instructions that, when executed by the one or more processors individually or collectively, cause the electronic device to:
identify that the communication error occurred between the first electronic device and the external device based on at least one of the dongle or the hub built in the first electronic device being in an error state.

3. The electronic device of claim 2, wherein the one or more computer programs include computer-executable instructions that, when executed by the one or more processors individually or collectively, cause the electronic device to:
based on the dongle being in the error state, control the first electronic device to transmit the first control command and the identification information of the external device stored in the first electronic device to the second electronic device.

4. The electronic device of claim 3, wherein the first electronic device is configured to:
transmit the first control command and the identification information of the external device to the second electronic device through an IP network by using the hub built in the first electronic device.

5. The electronic device of claim 2, wherein the one or more computer programs include computer-executable instructions that, when executed by the one or more processors individually or collectively, cause the electronic device to:
based on the hub built in the first electronic device being in the error state, transmit the first control command and the identification information of the external device stored in the first electronic device to the second electronic device through the communication interface.

6. The electronic device of claim 1, wherein the one or more computer programs include computer-executable instructions that, when executed by the one or more processors individually or collectively, cause the electronic device to:
identify that a communication error occurred between the second electronic device and the external device, and
transmit a third control command through the communication interface, the third control command including an instruction to control that:
the first control command and the identification information of the external device are transmitted to a third electronic device, among a plurality of electronic devices which are connected through the access point and in each of which a hub is built in, and
the third electronic device communicates with the external device to control the external device.

7. The electronic device of claim 6, wherein the one or more computer programs include computer-executable instructions that, when executed by the one or more processors individually or collectively, cause the electronic device to:
based on the strength of signals received among the plurality of electronic devices, identify priorities of the plurality of electronic devices on the basis of the first electronic device, and
identify the second electronic device as an electronic device among the plurality of electronic devices having the highest priority based on the priorities.

8. The electronic device of claim 6, wherein the one or more computer programs include computer-executable instructions that, when executed by the one or more processors individually or collectively, cause the electronic device to:
based on identifying that the communication error occurred between the second electronic device and the external device, identify the third electronic device as an electronic device among the plurality of electronic devices having the second highest priority after the second electronic device.

9. The electronic device of claim 1, wherein the near field communication is Zigbee communication.

10. A method performed by an electronic device configured to communicate with a first electronic device and a second electronic device, in each of which a hub is built in, through an access point, the method comprising:
based on receiving a user input for controlling an external device connected to the first electronic device, transmitting a first control command to the first electronic device, the first control command including an instruction for controlling the external device;
identifying that a communication error occurred between the first electronic device and the external device; and
transmitting a second control command including an instruction for controlling that:
the first control command and identification information of the external device transmitted to the second electronic device, and
the second electronic device communicates with the external device to control the external device,
wherein the identification information of the external device is obtained by the first electronic device through near field communication.

11. The method of claim 10,
wherein the first electronic device is configured to:
communicate with the external device through a dongle connected to the first electronic device, and
wherein the identifying that the communication error occurred between the first electronic device and the external device is based on at least one of the dongle or the hub built in the first electronic device being in an error state.

12. The method of claim 11, further comprising:
based on the dongle being in the error state, controlling the first electronic device to transmit the first control command and the identification information of the external device stored in the first electronic device to the second electronic device.

13. The method of claim 12, wherein the first electronic device is configured to:
transmit the first control command and the identification information of the external device to the second electronic device through an IP network by using the hub built in the first electronic device.

14. The method of claim 11, further comprising:
based on the hub built in the first electronic device being in the error state, transmitting the first control command and the identification information of the external device stored in the first electronic device to the second electronic device.

15. The method of claim 10, further comprising:
identifying that a communication error occurred between the second electronic device and the external device; and
transmitting a third control command including an instruction to control that:
the first control command and the identification information of the external device are transmitted to a third electronic device, among a plurality of electronic devices which are connected through the access point and in each of which a hub is built in, and
the third electronic device communicates with the external device to control the external device.

16. The method of claim 15, further comprising:
based on the strength of signals received among the plurality of electronic devices, identifying priorities of the plurality of electronic devices on the basis of the first electronic device, and
identifying the second electronic device as an electronic device among the plurality of electronic devices having the highest priority based on the priorities.

17. The method of claim 15, further comprising:
based on identifying that the communication error occurred between the second electronic device and the external device, identifying the third electronic device as an electronic device among the plurality of electronic devices having the second highest priority after the second electronic device.

18. One or more non-transitory computer-readable storage media storing one or more computer programs including computer-executable instructions that, when executed by one or more processors of an electronic device configured to communicate with a first electronic device and a second electronic device, in each of which a hub is built in, through an access point, individually or collectively, cause the electronic device to perform operations, the operations comprising:
based on receiving a user input for controlling an external device connected to the first electronic device, transmitting a first control command to the first electronic device, the first control command including an instruction for controlling the external device;
identifying that a communication error occurred between the first electronic device and the external device; and
transmitting a second control command including an instruction for controlling that:
the first control command and identification information of the external device transmitted to the second electronic device, and
the second electronic device communicates with the external device to control the external device,
wherein the identification information of the external device is obtained by the first electronic device through near field communication.

19. The one or more non-transitory computer-readable storage media of claim 18, the operations further comprising:
wherein the first electronic device is configured to:
communicate with the external device through a dongle connected to the first electronic device, and
wherein the identifying that the communication error occurred between the first electronic device and the external device is based on at least one of the dongle or the hub built in the first electronic device being in an error state.

20. The one or more non-transitory computer-readable storage media of claim 19, further comprising:
based on the dongle being in the error state, controlling the first electronic device to transmit the first control command and the identification information of the external device stored in the first electronic device to the second electronic device.
